(19) United States
(12) Patent Application Publication
(10) Pub. No.: US 2022/0093916 A1
(43) Pub. Date: Mar. 24, 2022

(54) MULTILAYERED CATHODE HAVING TAILORED CRYSTALLINITIES

(71) Applicant: EnPower, Inc., Phoenix, AZ (US)

(72) Inventors: Adrian YAO, Phoenix, AZ (US); Jonathan HWANG, Phoenix, AZ (US)

(21) Appl. No.: 17/474,861

(22) Filed: Sep. 14, 2021

Related U.S. Application Data
(60) Provisional application No. 63/080,272, filed on Sep. 18, 2020.

(51) Int. Cl. H01M 4/36; H01M 4/62; H01M 4/525; H01M 4/04; H01M 4/1391; H01M 10/0525; H01M 4/131

(52) U.S. Cl. CPC H01M 4/366; H01M 4/625; H01M 4/525; H01M 4/0435; H01M 2004/028; H01M 4/1391; H01M 10/0525; H01M 4/131; H01M 4/0404

(57) ABSTRACT

A cathode including a current collector, a first layer including a first active material composite disposed on the current collector, a second layer including a second active material composite disposed on the first layer, and a separator disposed on the second layer. The first and second active material composites include particles have tailored crystallinities to improve cathode stability and performance. In some examples, the first active material composite includes more polycrystalline active material particles than the second active material layer.

### CROSS-REFERENCES

The following applications and materials are incorporated herein, in their entireties, for all purposes: U.S. Provisional Patent Application Ser. No. 63/080,272, filed Sep. 18, 2020.

### FIELD

This disclosure relates to systems and methods for electrodes for electrochemical cells. More specifically, the disclosed embodiments relate to cathodes.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), nickel manganese cobalt oxide (NMC), nickel cobalt aluminum oxide (NCA), lithium ion (Li-ion), and lithium-ion polymer (Li-ion polymer).

### SUMMARY

The present disclosure provides systems, apparatuses, and methods relating to multilayered cathodes having tailored particle crystallinities.

In some examples, a cathode for an electrochemical cell includes: a current collector; a first layer disposed on and directly contacting the current collector, the first layer comprising a first plurality of active material particles comprising polycrystalline active material particles; and a second layer disposed on and directly contacting the first layer, the second layer comprising a second plurality of active material particles comprising at least 50% single-crystal active material particles by volume.

In some examples, a cathode for an electrochemical cell includes: a current collector; an electrochemically inactive carbon conductive layer disposed on the current collector; a first layer disposed on the electrochemically inactive carbon conductive layer, the first layer comprising a plurality of active material particles comprising polycrystalline active material particles; and a second layer disposed on the first layer, the second layer comprising a second plurality of active material particles comprising at least 50% single-crystal active material particles by volume.

In some examples, a method of manufacturing a cathode includes: layering an electrochemically inactive carbon conductive material onto a current collector. layering a first active material composite including a plurality of first active material particles onto the electrochemically inactive carbon conductive material, the first active material particles comprising polycrystalline active materials; and layering a second active material composite including a plurality of second active material particles onto the first active material composite, the second active material particles including at least 50% single-crystal active material particles.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 a schematic sectional view of an illustrative electrochemical cell.

FIG. 2 is a graph showing a battery voltage in response to currents applied in stepped charge protocols.

FIG. 3 is a scanning electron microscope (SEM) image of polycrystalline cathode active material particles, illustrating cracking of materials near a separator surface of an electrode in response to high current.

FIG. 4 is a SEM image of first illustrative cathodes including single-crystal cathode materials disposed near a separator layer and polycrystalline cathode materials disposed near a current collector.

FIG. 5 is a schematic sectional view of one of the cathodes of FIG. 4.

FIG. 6 is a sectional view of an illustrative interlocking region of the cathodes of FIG. 4.

FIG. 7 is a schematic sectional view of a second illustrative cathode in accordance with aspects of the present disclosure.

FIG. 8 is a schematic sectional view of a third illustrative cathode in accordance with aspects of the present disclosure.

FIG. 9 is a flow chart depicting steps of an illustrative method for manufacturing cathodes in accordance with aspects of the present disclosure.

FIG. 10 is a sectional view of an illustrative electrode undergoing a calendering process in accordance with aspects of the present disclosure.

FIG. 11 is a schematic diagram of an illustrative manufacturing system suitable for manufacturing cathodes and electrochemical cells of the present disclosure.

### DETAILED DESCRIPTION

Various aspects and examples of a multilayered cathode having tailored particle crystallinities, as well as related methods, are described below and illustrated in the associated drawings. Unless otherwise specified, a multilayered cathode in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses.

Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

Terms such as “top” and “bottom” should be understood in relation to a cathode including a current collector and a separator, where the cathode is oriented such that the current collector is beneath the cathode bulk. The “top” therefore indicates the separator side of the cathode, and the “bottom” refers to the current collector side.

“Coupled” means connected, either permanently or releasably, whether directly or indirectly through intervening components.

“Providing,” in the context of a method, may include receiving, obtaining, purchasing, manufacturing, generating, processing, preprocessing, and/or the like, such that the object or material provided is in a state and configuration for other steps to be carried out.

“Single-crystal” materials are monocrystalline particles having long-range order in their atomic structure within the entire bulk of the material particle. In contrast, “polycrystalline” material particles comprise a plurality of monocrystalline “grains”, each roughly ˜1 μm or less in size, that together make up a particle including “grain boundaries” disposed between grains.

“High nickel content cathodes” are cathodes having a stoichiometric nickel percentage greater than or equal to 80%. In contrast, “low nickel content cathodes” are cathodes having a stoichiometric nickel percentage less than 70%.

“NCA” means a transition metal oxide having nickel, cobalt, and aluminum as its primary transition metal elements.

“NMC” means a transition metal oxide having nickel, manganese, and cobalt as its primary transition metal elements.

“Electrochemically inactive” or “non-electrochemically active” refers to a material does not exhibit chemical reaction or intercalation with the working ions (e.g., lithium ions) of an electrochemical device. Electrochemically inactive materials in the examples below may include particles having internal porosities or conduction channels through the particles, but the particles do not chemically interact with the ions in any substantive way.

“D50” refers to the mass-median-diameter, corresponding to an average particle size by mass. Unless otherwise indicated, particle sizes referenced herein should be understood in D50 terms.

“Microporous” refers to a material containing pores having diameters less than 2 nanometers (nm).

“Mesoporous” refers to a material containing pores having diameters of 2 nm to 500 nm.

“Macroporous” refers to a material containing pores having diameters greater than 500 nm.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

Fast-charging lithium-ion electrochemical cells (AKA batteries) involve rapid delithiation of cathode active materials. In general, rapid delithiation applies a large amount of stress to active material particles disposed closer to a separator within the cell (or other interface between cathode and anode). Monocrystalline or single-crystal active materials are generally more resistant to stress than polycrystalline active materials. Cathodes having single-crystal active materials disposed closer to the separator and polycrystalline active materials disposed farther away from the separator may be resistant to negative affects resulting from applied stress (e.g., particle cracking, increased impedance, electrode instability, etc.).

In general, a cathode in accordance with the present teachings may have a first layer including a first active material composite (AKA first active material blend) and a second layer including a second active material composite (AKA second active material blend). The cathode may be sandwiched between a first current collector and a separator, with the first layer adjacent the first current collector and the second layer adjacent the separator. The first and second active material composites include active material particles, which may comprise transition metal oxides, as well as binders, conductive additives, and/or pores (AKA void space).

The active material layers include particles having tailored crystallinities selected to improve cathode stability and efficiency. Each layer includes one or both of: (a) polycrystalline active material particles, with each active material particle comprising a plurality of monocrystalline grains, and (b) monocrystalline or single-crystal active material particles, with each active material particle comprising a single-crystal of material.

In general, the first active material composite comprises polycrystalline active material particles, as the first layer is disposed between the current collector and the second layer. In some examples, the first active material composite comprises at least 90% polycrystalline active material particles. In some examples, the first active material composite includes a bi-modal distribution of polycrystalline and single crystal materials. In some examples, the first active material composite comprises at least 50% polycrystalline active material particles. In some examples, the first active material composite comprises at least 99% polycrystalline active material particles. The second active material composite comprises a mixture of polycrystalline active material particles and single-crystal active material particles, which are more resistant to grain cracking. The second active material composite includes at least 50% single-crystal active material particles. In some examples, the second active material composite includes at least 60% single-crystal active material particles. In some examples, the second active material composite includes at least 90% single-crystal active material particles.

In some examples, the active particles may comprise NCA-type materials, which include transition metal oxides having nickel, cobalt, and aluminum as primary transition metal elements. In some examples, the active particles comprise NMC, which is a transition metal oxide having nickel, manganese, and cobalt as the primary transition metal elements.

In some examples, the cathode includes non-electrochemically active (AKA electrochemically inactive) carbon particles configured to improve ionic conductivity within the electrode. In some examples, the cathode includes a non-electrochemically active carbon conductive layer disposed between the first layer and the current collector. In some examples, the cathode includes porous carbon conductive particles disposed within the second layer, which are configured to provide ion conduction channels within the second layer.

In some examples, the cathode is included in an electrochemical cell such as a lithium-ion battery. The electrochemical cell may include an anode disposed adjacent the separator, such that the cathode is disposed adjacent a first side of the separator and the anode is disposed adjacent a second side of the separator. The anode may be sandwiched between the separator and a second current collector. The anode may include an anode active material composite including anode active material particles, conductive additives, and pores. The electrochemical cell may include an electrolyte disposed throughout the anode and cathode.

A method of manufacturing a cathode including tailored crystallinities may include providing a substrate, applying a first layer of cathode active material to the substrate, applying a second layer of cathode active material to the substrate, and drying and/or calendering the cathode. In some examples, the first and second layers of cathode active material may be applied simultaneously, such that a plurality of interpenetrating fingers are formed between the first and second layers.

### EXAMPLES, COMPONENTS, AND ALTERNATIVES

The following sections describe selected aspects of illustrative cathodes including tailored crystallinities as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

This section describes an electrochemical cell including a cathode according to the present teachings. The electrochemical cell may be any bipolar electrochemical device, such as a battery (e.g., lithium-ion battery, secondary battery).

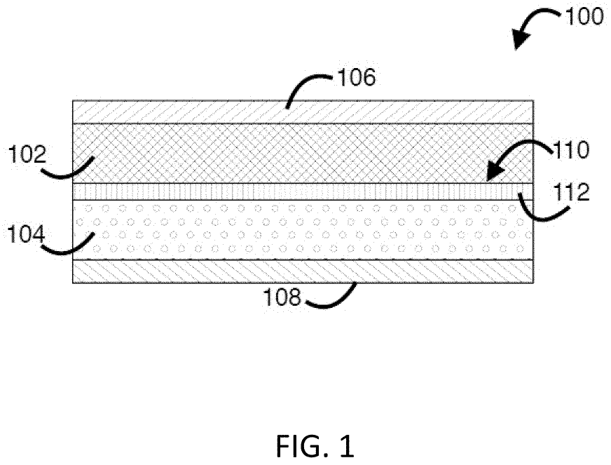

Referring now to FIG. 1, an electrochemical cell 100 is illustrated schematically in the form of a lithium-ion battery. Electrochemical cell 100 includes a positive and a negative electrode, namely a cathode 102 and an anode 104. The cathode and anode are sandwiched between a pair of current collectors 106, 108, which may comprise metal foils and/or other suitable substrates. Current collector 106 is electrically coupled to cathode 102, and current collector 108 is electrically coupled to anode 104. The current collectors enable the flow of electrons, and thereby electrical current, into and out of each electrode. An electrolyte 110 disposed throughout the electrodes enables the transport of ions between cathode 102 and anode 104. In the present example, electrolyte 110 includes a liquid solvent and a solute of dissolved ions. Electrolyte 110 facilitates an ionic connection between cathode 102 and anode 104.

Electrolyte 110 is assisted by a separator 112, which physically partitions the space between cathode 102 and anode 104. Separator 112 is liquid-permeable and enables the movement (flow) of ions within electrolyte 110 and between the two electrodes. In some embodiments, electrolyte 110 includes a polymer gel and/or solid ion conductor, augmenting and/or replacing (and performing the function of) separator 112.

Cathode 102 and anode 104 are composite structures, which comprise active material particles, binders, conductive additives, and pores (void space) into which electrolyte 110 may penetrate. An arrangement of the constituent parts of an electrode is referred to as a microstructure, and/or more specifically, an electrode microstructure.

In some examples, the binder is a polymer, e.g., polyvinylidene difluoride (PVdF), and the conductive additive typically includes a nanometer-sized carbon, e.g., carbon black and/or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber.

In some examples, the chemistry of the active material particles differs between cathode 102 and anode 104. For example, anode 104 may include graphite (artificial or natural), hard carbon, titanate, titania, transition metals in general, elements in group 14 (e.g., carbon, silicon, tin, germanium, etc.), oxides, sulfides, transition metals, halides, and/or chalcogenides. On the other hand, cathode 102 may include transition metals (for example, nickel, cobalt, manganese, copper, zinc, vanadium, chromium, iron), and their oxides, phosphates, phosphites, and/or silicates. The cathode may include alkalines and alkaline earth metals, aluminum, aluminum oxides and aluminum phosphates, as well as halides and/or chalcogenides. In an electrochemical device, active materials participate in an electrochemical reaction or process with a working ion to store or release energy. For example, in a lithium-ion battery, the working ions are lithium ions.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

For electrochemical cell 100 to properly function as a secondary battery, active material particles in both cathode 102 and anode 104 must be capable of storing and releasing lithium ions through the respective processes known as lithiating and delithiating. Some active materials (e.g., layered oxide materials or graphitic carbon) fulfill this function by intercalating lithium ions between crystal layers. Other active materials may have alternative lithiating and delithiating mechanisms (e.g., alloying, conversion).

When electrochemical cell 100 is being charged, anode 104 accepts lithium ions while cathode 102 donates lithium ions. When a cell is being discharged, anode 104 donates lithium ions while cathode 102 accepts lithium ions. Each composite electrode (i.e., cathode 102 and anode 104) has a rate at which it donates or accepts lithium ions that depends upon properties extrinsic to the electrode (e.g., the current passed through each electrode, the conductivity of the electrolyte 110) as well as properties intrinsic to the electrode (e.g., the solid state diffusion constant of the active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging) anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is lesser than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid-state diffusion coefficient of lithium ions in an active material particle; and/or a particle size distribution of active material within a composite electrode. In some examples, additional or alternative factors may contribute to the electrode microstructure and affect these rates.

### B. Illustrative Cathode Active Materials

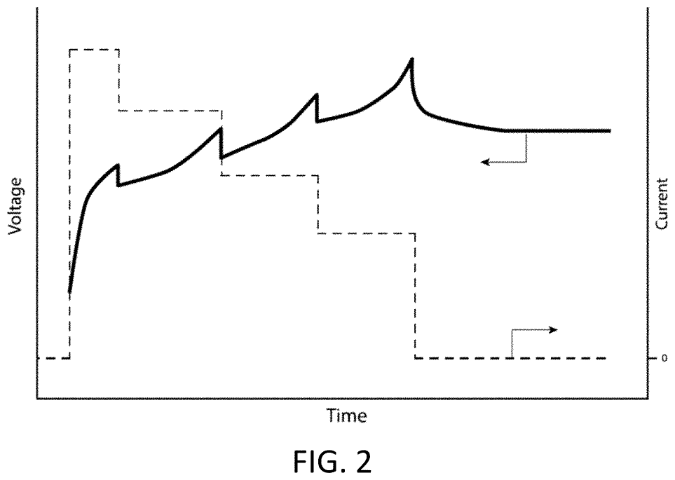

Fast charging of electrochemical cells involves rapid delithiation of cathode materials. As stated above, cathode active material particles included in fast-charging electrochemical cells are subjected to high levels of stress, especially at portions of the cathode disposed closer to a separator or other cathode-anode interface. More specifically, with stepped charge protocols or constant power charge protocols, comparatively high currents are experienced by electrodes at the beginning of the charging process. This is illustrated in FIG. 2, which shows currents applied in a stepped charging protocol over time (dashed-line) and a resulting change in voltage within the electrochemical cell (solid line).

Due to mass-transport limitations, cathode active materials disposed closest to a separator or other cathode-anode interface are delithiated first. High-energy density cell designs generally include thick, dense cathodes, which results in cathode active materials near the separator becoming over-delithiated. Cathode active materials near the separator may experience substantially more stress than active materials disposed closer to the current collector.

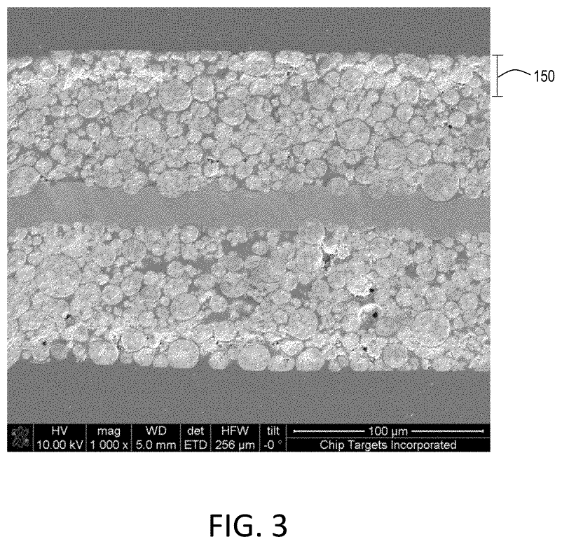

Over-delithiation can cause permanent damage to crystal structures of active material particles. Polycrystalline cathode active materials may experience stress-induced particle cracking along individual grain boundaries, as polycrystalline cathode active material particles are composites of monocrystalline grains. This cracking is generally due to volumetric changes affecting each crystal grain upon delithiation and lithiation, which causes stress along intergranular boundaries. Cathodes including only polycrystalline active materials are depicted in the scanning electron microscope (SEM) image of FIG. 3. Particle cracking is visible in particles disposed near the separator. In contrast, polycrystalline particles disposed closer to the current collector do not exhibit particle cracking and have maintained structural integrity. Particle cracking results in an increase in the cathode material surface area exposed to electrolyte. The increased exposure results in an increase in side reactions (i.e., reactions between cathode active particles and electrolyte), and the side reactions increase overall cell impedance and detrimentally affect cycle performance.

Selected active particles in individual cathode layers may have tailored crystallinities to reduce cracking near the separator and to reduce the number of side reactions resulting from increased surface area exposure. Cathode active particles may comprise single-crystal or polycrystalline materials. Single-crystal materials include monocrystalline particles having long-range order in their atomic structure within the entire bulk of the material particle. Single-crystal material particles may have particle sizes (e.g., D50) between 1 μm and 8 μm.

Under magnification, individual particles within single-crystal materials may have a “faceted” exterior appearance, having a smooth surface and no grain boundaries. A majority of single-crystal materials comprise primary particles. Single-crystal cathode materials generally have a higher overall surface area than polycrystalline cathode materials, as the single-crystal materials have smaller effective particle sizes.

In contrast, polycrystalline material particles are each made up of a plurality of smaller monocrystalline grains or portions, which may each be roughly 1 μm or less in size. The grains collectively form a polycrystalline particle having grain boundaries, and the polycrystalline particle has a reduced exposed surface area for side reactions when compared with the grains as independent particles. Single-crystal material particles are generally synthesized to have larger monocrystalline particle sizes when compared to the grains of the polycrystalline material particles. The polycrystalline material particles may have particle sizes (e.g., D50) between 5 μm and 30 μm. Under magnification, polycrystalline particles may have a textured (e.g., “grainy” or “rough”) exterior appearance, with identifiable grain boundaries. Polycrystalline particles are generally spherical in morphology and comprise numerous secondary particles (AKA subparticles) agglomerated into a larger particle. Polycrystalline materials (when uncracked or unstressed) generally have a lower overall specific surface area (m²/g) than single-crystal materials, as overall particle sizes of the polycrystalline materials are larger.

Generally, cathode active materials may be either a single-crystal or a polycrystalline material. Polycrystalline particles may be susceptible to interparticle cracking, which can negatively affect cathode cycle life, whereas single-crystal materials may be resistant to particle cracking due to a lack of internal grain boundaries. Single-crystal materials may also have higher solid-state diffusion rates due to a lack of grain boundaries that increase impedance, resulting in faster lithiation and delithiation. However, single-crystal materials may be more difficult to synthesize or manufacture, and therefore more expensive.

### C. First Illustrative Multilayered Cathode

Operation of an electrochemical cell or battery disproportionately uses portions of the cathode disposed adjacent to the separator (referred to herein as the “top portion”). It can therefore be beneficial to include stable active materials in the top portion of the electrode to increase the cycle life of the electrochemical cell.

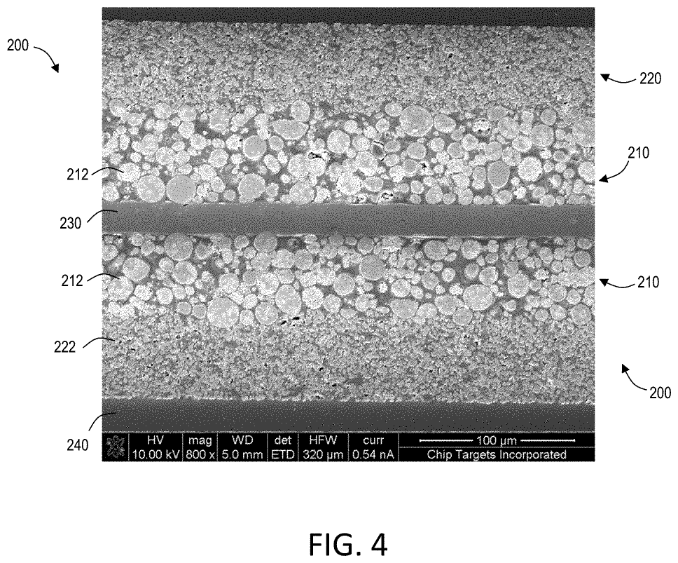

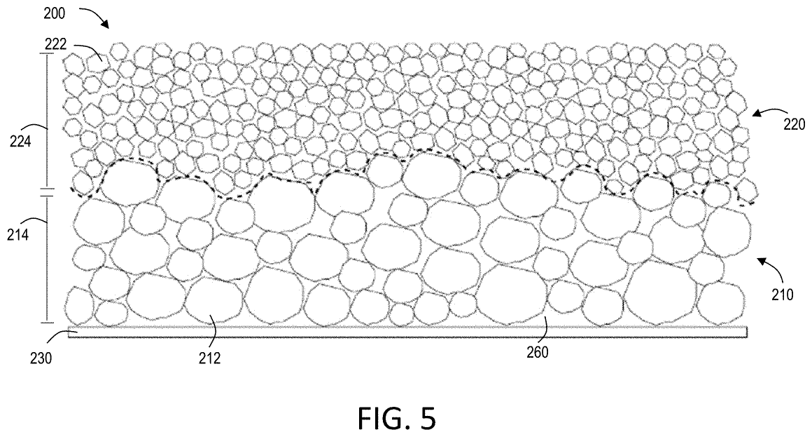

FIGS. 4 and 5 depict a first illustrative multilayered cathode 200 including a top layer 220 and a bottom layer 210. FIG. 4 is a scanning electron microscope (SEM) image of two cathodes 200, each including a top layer 220 and a bottom layer 210. In some examples, a separator (not shown) is disposed on and in direct contact with each top layer. In FIG. 4, a current collector 230 is disposed between and in direct contact with the bottom layers of both cathodes. FIG. 5 is a schematic sectional view of a single one of cathodes 200 of FIG. 4.

The bottom layer (AKA first layer) is disposed on and directly contacts a current collector 230 and includes a plurality of first active material particles 212, which may comprise polycrystalline active materials, as described above. The top layer (AKA second layer) is disposed on and directly contacts the bottom layer, and includes a plurality of second active material particles 222, which may comprise single-crystal active materials or a mixture of polycrystalline and single-crystal active materials. In some examples, the second active material particles comprise at least 50% single-crystal active materials. Single-crystal active materials may be selected for their resistance to grain cracking and for their higher solid-state diffusion rates, which may increase a charging speed of the cathode and increase cathode stability. In some examples, the second active material particles comprise at least 90% single-crystal materials.

The respective active material particles in both the top and bottom layers may be mixed with binders, conductive additives, and/or other additives to form active material composites. In some examples, the binder is a fluorine-based chemical, e.g., polyvinylidene difluoride (PVdF), polytetrafluoroethylene (PTFE), and the conductive additive typically includes a nanometer-sized carbon, e.g., carbon black or graphite. In some examples, the binder is a polymer, such as carboxyl-methyl cellulose (CMC), styrene-butadiene rubber (SBR), polyvinyl alcohol, and/or a mixture thereof. In some examples, the conductive additive includes a ketjen black, a graphitic carbon, a low dimensional carbon (e.g., carbon nanotubes), and/or a carbon fiber. In some examples, cathode 200 includes a lower concentration of binder in top layer 220 than in bottom layer 210. In some examples, a binder concentration ratio between the bottom layer and the top layer is greater than 1. In some examples, cathode 200 includes a higher carbon concentration in bottom layer 210 than in top layer 220. In some examples, a carbon concentration ration between the bottom layer and the top layer is greater than 1. In some examples, an electrolyte 260 is disposed throughout the cathode.

First active material particles 212 and second active material particles 222 may comprise transition metal oxides, as described above. In some examples, the first and/or second active material particles may include NCA-type materials, NMC, and/or other suitable nickel-based transition metal oxides. In some examples, the first active material particles and the second active material particles include nickel-based transition metal oxides having a stoichiometric nickel percentage of at least 60%. In some examples, the first and second active material particles comprise NMC. In some examples, the first and second active material particles comprise NMC811, which is a nickel-containing transition metal oxide including 80% nickel, 10% manganese, and 10% cobalt. In some examples, first active material particles 212 have a higher stoichiometric nickel percentage than second active material particles 222.

In some examples, first layer 210 has a first thickness 214 and second layer 220 has a second thickness 224. In some examples, a ratio between second thickness 224 and first thickness 214 is 1:3 to 3:1. In some examples, a ratio between second thickness 224 and first thickness 214 is 1:1. In some examples, cathode 200 has a thickness of 50 μm to 150 μm.

In some examples, a majority of first active material particles 212 have a greater roughness factor than a majority of second active material particles 222 due to the grain boundaries of the polycrystalline active particles. In some examples, first active material particles 212 have a larger average particle size (e.g., greater than 15 μm) than second active material particles 222 (e.g., less than 15 μm). In some examples, first active material particles 212 have a lower overall surface area than second active material particles 222.

This configuration of layers facilitates a crack-resistant cathode, while balancing overall cell cost. As charging currents in a stepped charge protocol decrease over time, polycrystalline active materials in the bottom layer will delithiate at gentler rates than active materials included in the top layer.

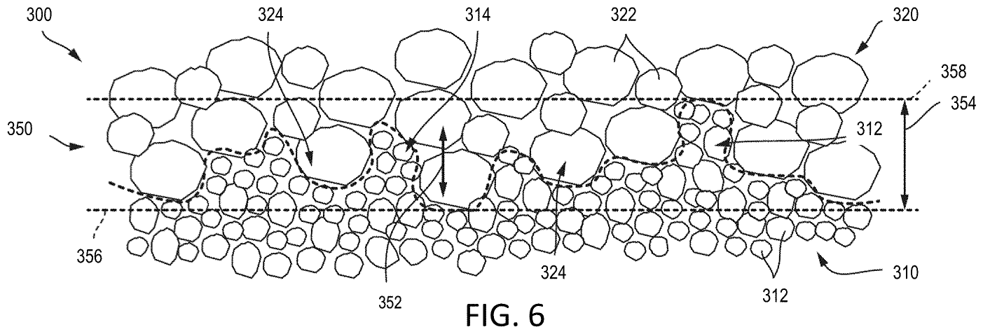

As shown in FIG. 6, in some examples, multilayered cathode 300 includes an interlocking region disposed between the top and the bottom layers. Interlocking region 350 may comprise a non-planar boundary between bottom layer 310 and top layer 320, which may be configured to decrease interfacial resistance between the layers and reduce lithium plating. Bottom layer 310 and top layer 320 may have respective, three-dimensional, interpenetrating fingers 314 and 324 interlocking the two layers together, forming a mechanically robust interface that is capable of withstanding stresses, such as those due to electrode expansion and compression. Additionally, the non-planar surfaces defined by fingers 314 and fingers 324 represent an increased total surface area of the interface boundary, which may provide increased interfacial resistance and may increase ion mobility through the electrode. Fingers 314 and 324 may be interchangeably referred to as fingers, protrusions, extensions, projections, and/or the like. Furthermore, the relationship between fingers 314 and 324 may be described as interlocking, interpenetrating, intermeshing, interdigitating, interconnecting, interlinking, and/or the like.

Fingers 314 and fingers 324 are a plurality of substantially discrete interpenetrations, wherein fingers 314 are generally made up of first active material particles 312 and fingers 324 are generally made up of second active material particles 322. The fingers are three-dimensionally interdigitated, analogous to an irregular form of the stud-and-tube construction of Lego bricks. Accordingly, fingers 314 and 324 typically do not span the electrode in any direction, such that a cross section perpendicular to that of FIG. 6 will also show a non-planar, undulating boundary similar to the one shown in FIG. 6. Interlocking region 350 may alternatively be referred to as a non-planar interpenetration of bottom layer 310 and top layer 320, including fingers 314 interlocked with fingers 324.

Although fingers 314 and 324 may not be uniform in size or shape, the fingers may have an average or typical length 352. In some examples, length 352 of fingers 314 and 324 falls in a range of two to five times the average particle size of the bottom layer or the top layer, whichever is smaller. In some examples, length 352 of fingers 314, 324 falls in a range of six to ten times the average particle size of the bottom layer or the top layer, whichever is smaller. In some examples, length 352 of fingers 314 and 324 falls in a range of eleven to fifty times the average particle size of the bottom layer or the top layer, whichever is smaller. In some examples, length 352 of fingers 314 and 324 is greater than fifty times the average particle size of the bottom layer or the top layer, whichever is smaller.

In some examples, length 352 of fingers 314 and 324 fall in a range of approximately five hundred to approximately one thousand nanometers. In some examples, length 352 of fingers 314 and 324 falls in a range of approximately one to approximately five μm. In some examples, length 352 of fingers 314 and 324 falls in a range between approximately six and approximately ten μm. In another example, length 352 of fingers 314 and 324 falls in a range of approximately eleven to approximately fifty μm. In some examples, length 352 of fingers 314 and 324 is greater than approximately fifty μm.

In the present example, a total thickness 354 of interlocking region 350 is defined by the level of interpenetration between the two electrode material layers (bottom layer 310 and top layer 320). A lower limit 356 may be defined by the lowest point reached by top layer 320 (i.e., by fingers 324). An upper limit 358 may be defined by the highest point reached by bottom layer 310 (i.e., by fingers 314). Total thickness 354 of interlocking region 350 may be defined as the separation or distance between limits 356 and 358. In some examples, the total thickness of interlocking region 350 falls within one or more of various relative ranges, such as approximately 100% (1×) to approximately 500% (5×), approximately 500% (5×) to approximately 1000% (10×), approximately 1000% (10×) to approximately 5000% (50×), and/or greater than approximately 5000% (50×) of the average particle size of the bottom layer or the top layer, whichever is smaller.

In some examples, total thickness 354 of interlocking region 350 falls within one or more of various absolute ranges, such as approximately 500 to one thousand nanometers, one to approximately ten μm, approximately ten to approximately fifty μm, and/or greater than approximately fifty μm.

In the present example, first active material particles 312 and second active material particles 322 are substantially spherical in particle morphology. In some examples, one or both of the plurality of particles in either the bottom layer or the top layer have particle morphologies that are: spherical, platelet-like, irregular, potato-shaped, oblong, fractured, agglomerates of smaller particle types, and/or a mixture of the above.

When particles of cathode 300 are lithiating or delithiating, cathode 300 remains coherent, and the bottom layer and the top layer remain bound by interlocking region 350. In general, the interdigitation or interpenetration of fingers 314 and 324, as well as the increased surface area of the interphase boundary, function to adhere the two zones together.

During charging of the battery, first active material particles 312 and second active material particles 322 delithiate. During this process, the active material particles may contract, causing the bottom and top layers to contract. In contrast, during discharging of the battery, the active material particles lithiate and swell, causing the bottom and top layers to swell. During swelling and contracting, cathode 300 may remain coherent, and bottom layer 310 and top layer 320 remain bound by interlocking region 350. This bonding of the bottom layer and top layer may decrease interfacial resistance between the layers and maintain mechanical integrity of an electrochemical cell including the electrode. Interlocking region 350 may comprise a network of fluid passageways defined by active material particles, binder, conductive additives, and/or additional layer components. These fluid passages are not hampered by calendering-induced changes in mechanical or morphological state of the particles due to the non-planar boundary included in the interlocking region. In contrast, a substantially planar boundary is often associated with the formation of a crust layer upon subsequent calendering. Such a crust layer is disadvantageous as it can significantly impede ion conduction through the interlocking region. Furthermore, such a crust layer also represents a localized compaction of active material particles that effectively result in reduced pore volumes within the electrode.

### D. Second Illustrative Multilayered Cathode

Cathode active materials are naturally more resistive than anode materials. This increased resistivity may result in significant Joule heating upon high current delithiation. Providing a carbon-coating layer disposed between a first cathode layer and a current collector in a cathode may reduce Ohmic impedance within the cathode. The carbon-coating layer may improve heat dissipation within the electrode, reducing particle cracking due to Joule heating.

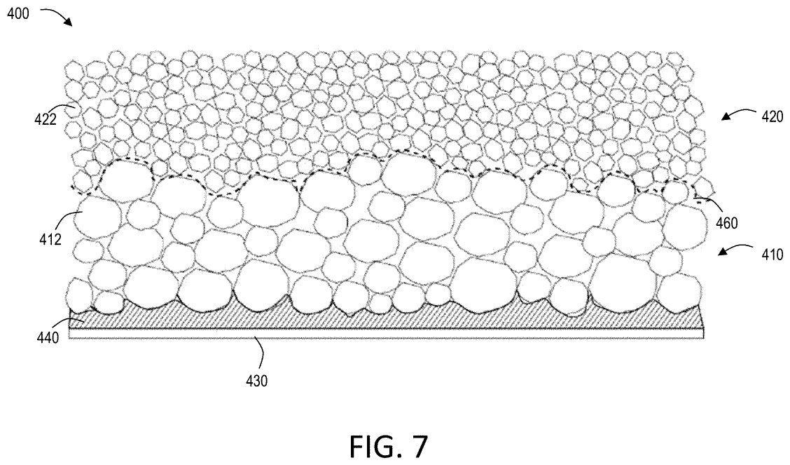

As shown in FIG. 7, this section describes a second illustrative multilayered cathode 400. Cathode 400 is an example of cathodes having tailored crystallinities, as described above. Cathode 400 includes a current collector 440, an electrochemically inactive carbon layer 430 disposed on and directly contacting current collector 440, a first active material layer (AKA bottom layer) 410 disposed on and directly contacting electrochemically inactive carbon layer 430, and a second active material layer (AKA top layer) 420 disposed on and directly contacting first active material layer 410. Cathode 400 may be substantially similar to cathodes 200 and 300, described above, except as otherwise described.

The bottom layer (AKA first layer 410) includes a plurality of first active material particles 412, which may comprise polycrystalline active materials, as described above. The top layer (AKA second layer 420) includes a plurality of second active material particles 422, which may comprise single-crystal active materials, or a mixture of polycrystalline and single-crystal active materials. In some examples, the second active material particles comprise at least 50% single-crystal active materials. Single-crystal active materials may be selected based on resistance to grain cracking and higher solid-state diffusion rates, which may increase a charging speed of the cathode and increase cathode stability.

The active material particles in both the top and bottom layers may be mixed with binders, conductive additives, and/or other additives to form an active material composite. In some examples, the binder is a fluorine-based chemical, e.g., polyvinylidene difluoride (PVdF), polytetrafluoroethylene (PTFE), and the conductive additive typically includes a nanometer-sized carbon, e.g., carbon black or graphite. In some examples, the binder is a polymer, such as carboxyl-methyl cellulose (CMC), styrene-butadiene rubber (SBR), polyvinyl alcohol, and/or a mixture thereof. In some examples, the conductive additive includes a ketjen black, a graphitic carbon, a low dimensional carbon (e.g., carbon nanotubes), and/or a carbon fiber. In some examples, cathode 400 includes a lower concentration of binder in top layer 420 than in bottom layer 410. In some examples, a binder concentration ratio between the bottom layer and the top layer is greater than 1. In some examples, cathode 400 includes a higher carbon concentration in bottom layer 410 than in top layer 420. In some examples, a carbon concentration ratio between the bottom layer and the top layer is greater than 1. An electrolyte 460 may be disposed throughout the cathode.

In some examples, electrochemically inactive carbon layer 430 comprises a conductive material, such as ketjen black, graphitic carbon, a low dimensional carbon (e.g., carbon nanotubes), a carbon fiber, and/or the like. In some examples, electrochemically inactive carbon layer 430 has a thickness between 1 μm and 10 μm. In some examples, the electrochemically inactive carbon layer 430 includes an aqueous binder material.

In some examples, cathode 400 includes an interlocking region disposed between the top and bottom layers. The interlocking region may be substantially as described with respect to cathode 300 in FIG. 6. The interlocking region may comprise a non-planar boundary between bottom layer 410 and top layer 420, which may be configured to decrease interfacial resistance between the layers and reduce lithium plating. In some examples, cathode 400 includes an interlocking region disposed between the electrochemically inactive carbon conductive layer and the bottom layer. The interlocking region may comprise a non-planar boundary between bottom layer 410 and electrochemically inactive carbon conductive layer 430, which may be configured to decrease interfacial resistance between the layers and reduce lithium plating.

### E. Third Illustrative Multilayered Cathode

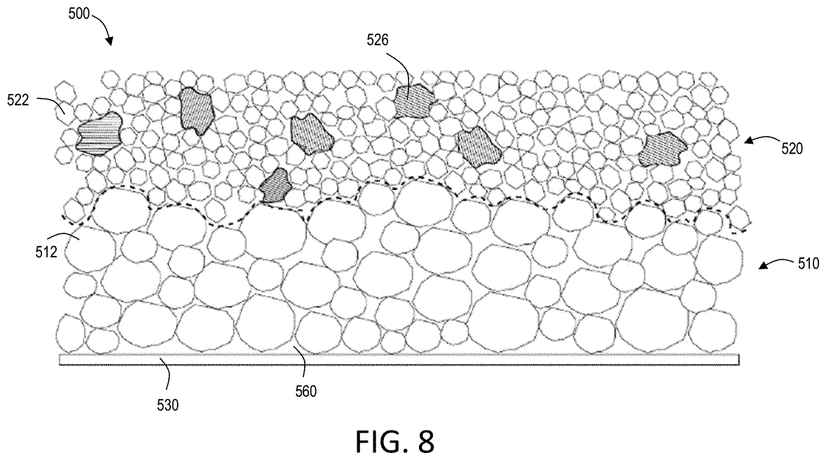

As shown in FIG. 8, this section describes a third illustrative multilayered cathode 500. Cathode 500 is an example of cathodes having tailored crystallinities, as described above. Cathode 500 includes a top layer 520, a bottom layer 510, and a current collector 530. Cathode 500 may be substantially identical to cathodes 200 and 300, described above, except as otherwise described.

Adding porous conductive particles to a top layer of the electrode may improve ionic conductivity within the top layer, and between the top layer and the bottom layer of the electrode. In some examples, the porous conductive particles comprise carbon.

The bottom layer (AKA first layer) is disposed on and directly contacts current collector 530 and includes a plurality of first active material particles 512, which may comprise polycrystalline active materials, as described above. The top layer (AKA second layer) is disposed on and directly contacts the bottom layer and includes a plurality of second active material particles 522, which may comprise single-crystal active materials, or a mixture of polycrystalline and single-crystal active materials. In some examples, the second active material particles comprise at least 50% single-crystal active materials. Single-crystal active materials may be selected based on resistance to grain cracking and higher solid-state diffusion rates, which may increase a charging speed of the cathode and increase cathode stability.

Second layer (AKA top layer) 520 includes a plurality of porous carbon conductive particles 526, which may be configured to provide ion conduction channels throughout the second layer and between the first layer and the second layer. Porous carbon conductive particles 526 may comprise any suitable electroconductive carbon, such as a ketjen black, a graphitic carbon, and/or the like. Porous carbon conductive particles 526 may be microporous, mesoporous, macroporous, and/or have any suitable porosity for conducting ions. In some examples, porous carbon conductive particles 526 contain pores having diameters less than 2 nanometers (nm). In some examples, porous carbon conductive particles 526 contain pores having diameters of 2 nm to 500 nm. In some examples, porous carbon conductive particles 526 contain pores having diameters greater than 500 nm.

The active material particles in both the top and bottom layers may be mixed with binders, conductive additives, and/or other additives to form an active material composite. In some examples, the binder is a fluorine-based chemical, e.g., polyvinylidene difluoride (PVdF), polytetrafluoroethylene (PTFE), and the conductive additive typically includes a nanometer-sized carbon, e.g., carbon black or graphite. In some examples, the binder is a polymer, such as carboxyl-methyl cellulose (CMC), styrene-butadiene rubber (SBR), polyvinyl alcohol, and/or a mixture thereof. In some examples, the conductive additive includes a ketjen black, a graphitic carbon, a low dimensional carbon (e.g., carbon nanotubes), and/or a carbon fiber. In some examples, cathode 500 includes a lower concentration of binder in top layer 520 than in bottom layer 510. In some examples, a binder concentration ratio between the bottom layer and the top layer is greater than 1. In some examples, cathode 500 includes a higher carbon concentration in bottom layer 510 than in top layer 520. In some examples, a carbon concentration ration between the bottom layer and the top layer is greater than 1. An electrolyte 560 may be disposed throughout the cathode.

In some examples, cathode 500 includes an interlocking region disposed between the top and bottom layers. The interlocking region may be substantially as described with respect to cathode 300 in FIG. 6. The interlocking region may comprise a non-planar boundary between bottom layer 510 and top layer 520, which may be configured to decrease interfacial resistance between the layers and reduce lithium plating.

### F. Illustrative Cathode Manufacturing Method

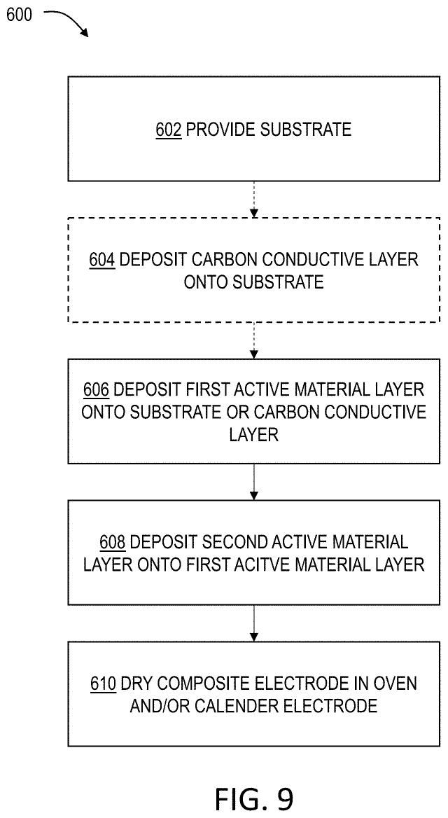

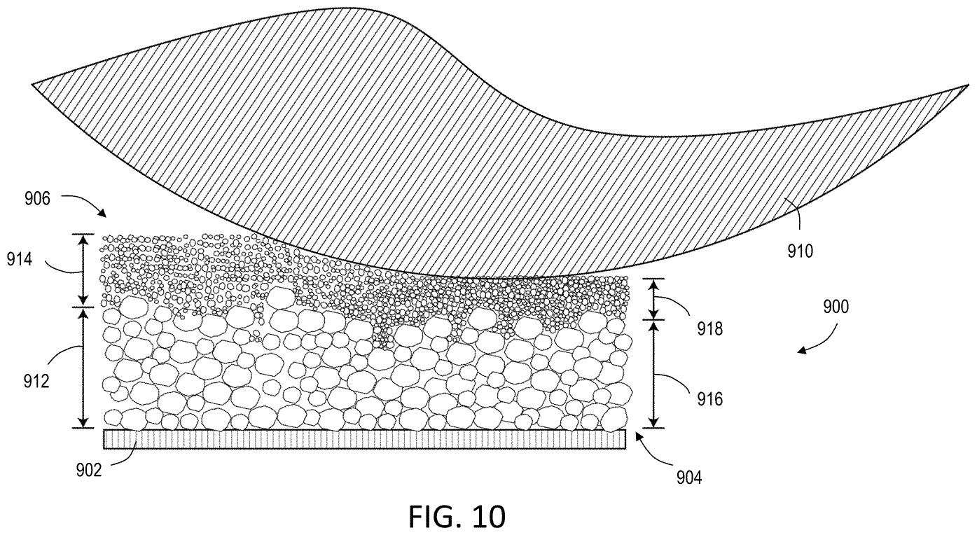

The following describes steps of an illustrative method 600 for forming a cathode including tailored crystallinities; see FIGS. 9-10.

Aspects of electrodes and manufacturing devices described herein may be utilized in the method steps described below. Where appropriate, reference may be made to components and systems that may be used in carrying out each step. These references are for illustration and are not intended to limit the possible ways of carrying out any particular step of the method.

FIG. 9 is a flowchart illustrating steps performed in an illustrative method and may not recite the complete process or all steps of the method. Although various steps of method 600 are described below and depicted in FIG. 9, the steps need not necessarily all be performed, and in some cases may be performed simultaneously, or in a different order than the order shown.

Step 602 of method 600 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out.

Method 600 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include one or more electrode layers, including a plurality of active material particles.

Optional step 604 of method 600 includes coating an electrochemically inactive carbon layer onto the current collector substrate. In some examples, the electrochemically inactive carbon layer comprises a plurality of carbon particles adhered together by a first binder. In some examples, the electrochemically inactive carbon layer comprises a conductive material, such as ketjen black, graphitic carbon, a low dimensional carbon (e.g., carbon nanotubes), a carbon fiber, and/or the like. In some examples, the electrochemically inactive carbon layer has a thickness between 1 μm and 10 μm.

The coating process of optional step 604 may include any suitable coating method(s), such as slot die, blade coating, spray-based coating, electrostatic jet coating, or the like. In some examples, the first layer is coated as a wet slurry of solvent, e.g., water or NMP(N-Methyl-2-pyrrolidone), binder, conductive additive, and active material. In some examples, the first layer is coated dry, as a carbon layer with a binder and/or a conductive additive. Step 604 may optionally include drying the electrochemically inactive carbon layer of the composite electrode.

Step 606 of method 600 includes coating a first active material layer of a composite cathode on a first side of the substrate or optionally applied electrochemically inactive carbon layer. The first layer includes a plurality of first active material particles adhered together by a first binder, the first particles having a first average particle size (or other first particle distribution). The first particles are selected to be substantially polycrystalline. In some examples, the first active material particles may comprise transition metals (for example, nickel, cobalt, manganese, copper, zinc, vanadium, chromium, iron), and their oxides, phosphates, phosphites, and silicates. The first active material particles may include alkalines and alkaline earth metals, aluminum, aluminum oxides and aluminum phosphates, as well as halides and chalcogenides. The first active material particles may include transition metal oxides such as NCA-type materials and NMC.

The coating process of step 606 may include any suitable coating method(s), such as slot die, blade coating, spray-based coating, electrostatic jet coating, or the like. In some examples, the first layer is coated as a wet slurry of solvent, e.g., water or NMP(N-Methyl-2-pyrrolidone), binder, conductive additive, and active material. In some examples, the first layer is coated dry, as an active material with a binder and/or a conductive additive. Step 606 may optionally include drying the first active material layer of the composite electrode.

Step 608 of method 600 includes coating a second active material layer onto the first active material layer, forming a multilayered (e.g., stratified) structure. The second active material layer may include a plurality of second active material particles adhered together by a second binder, the second particles having a second average particle size (or other second particle distribution). The second active material particles comprise at least 50% single-crystal active materials. In some examples, the second active material particles comprise 90% single-crystal active materials. In some examples, the second active material particles generally comprise single-crystal active materials. In some examples, the second active material particles may comprise transition metals (for example, nickel, cobalt, manganese, copper, zinc, vanadium, chromium, iron), and their oxides, phosphates, phosphites, and silicates. The second active material particles may include alkalines and alkaline earth metals, aluminum, aluminum oxides and aluminum phosphates, as well as halides and chalcogenides. The second active material particles may include transition metal oxides such as NCA-type materials and NMC. In these examples, the second layer may serve as a “shield” for the second layer against grain cracking due to high currents experienced in fast electrochemical cell charging.

The coating process of step 608 may include any suitable coating method(s), such as slot die, blade coating, spray-based coating, electrostatic jet coating, or the like. In some examples, the first second is coated as a wet slurry of solvent, e.g., water or NMP(N-Methyl-2-pyrrolidone), binder, conductive additive, and active material. In some examples, the second active material layer is coated dry, as an active material with a binder and/or a conductive additive.

In some examples, steps 606 and 608 may be performed substantially simultaneously. For example, both of the slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the first active material slurry and the second active material slurry may be tailored to cause interpenetrating finger structures at the boundary between the two composite layers. In some embodiments, the viscosities, surface tensions, densities, solids contents, and/or solvents may be substantially similar. Creation of interpenetrating structures, if desired, may be facilitated by turbulent flow at the wet interface between the first active material slurry and the second active material slurry, creating partial intermixing of the two slurries. In some examples, steps 604, 606, and 608 may be performed substantially simultaneously, and the three slurries may be extruded through their respective orifices simultaneously.

To facilitate proper curing in the drying process, the first active material layer (closest to the current collector) may be configured (in some examples) to be dried from solvent prior to the second active material layer (further from the current collector) so as to avoid creating skin-over effects and blisters in the resulting dried coatings.

In some examples, any of the described steps may be repeated to form three or more active material layers. For example, an additional layer or layers may include active materials. Any method described herein to impart structure between the first active material layer and the second active material layer may be utilized to form similar structures between any additional layers deposited during the manufacturing process.

Method 600 may further include drying the composite electrode in step 610, and/or calendering the composite electrode. Both the first and second layers may experience the drying process and the calendering process as a combined structure. In some examples, step 610 may be combined with calendering (e.g., in a hot roll process). In some examples, drying step 610 includes a form of heating and energy transport to and from the electrode (e.g., convection, conduction, radiation) to expedite the drying process. In some examples, calendering is replaced with another compression, pressing, or compaction process. In some examples, calendering the electrode may be performed by pressing the combined first and second layers against the substrate, such that electrode density is increased in a non-uniform manner, with the first layer having a first porosity and the second layer having a lower second porosity.

FIG. 10 shows an electrode undergoing the calendering process, in which particles in a second layer 906 can be calendered with a first layer 904. This may prevent a “crust” formation on the electrode, specifically on the first active material layer. A roller 910 may apply pressure to a fully assembled electrode 900. Electrode 900 may include first layer 904 and second layer 906 applied to a substrate web 902. First layer 904 may have a first uncompressed thickness 912 and second layer 906 may have a second uncompressed thickness 914 prior to calendering. After the electrode has been calendered, first layer 904 may have a first compressed thickness 916 and second layer 906 may have a second compressed thickness 918.

### G. Illustrative Manufacturing System

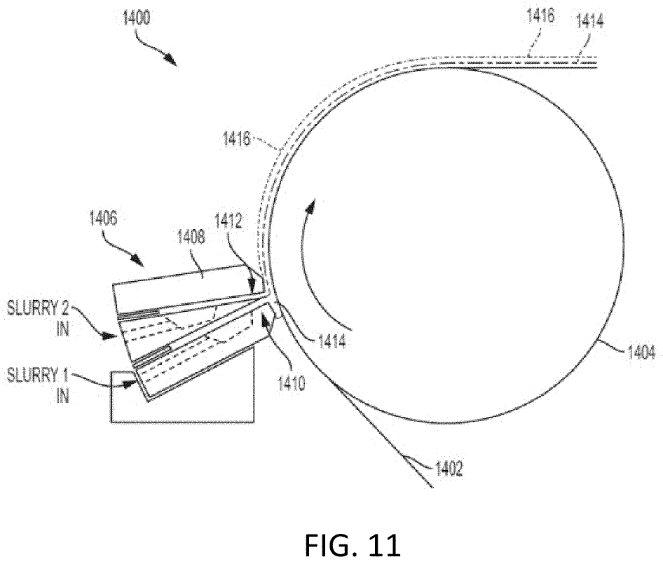

Turning to FIG. 11, an illustrative manufacturing system 1400 for use with method 600 will now be described. In some examples, a slot-die coating head with at least two fluid slots, fluid cavities, fluid lines, and fluid pumps may be used to manufacture a cathode having tailored crystallinities. The cathode may include a top and a bottom active material layer, each including particles having selected crystallinities. In some examples, additional cavities may be used to create additional active material layers.

In system 1400, a foil substrate 1402 is transported by a revolving backing roll 1404 past a stationary dispenser device 1406. Dispenser device 1406 may include any suitable dispenser configured to evenly coat one or more layers of slurry onto the substrate. In some examples, the substrate may be held stationary while the dispenser head moves. In some examples, both may be in motion. Dispenser device 1406 may, for example, include a dual chamber slot die coating device having a coating head 1408 with two orifices or slots 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer. In the present disclosure, the first layer 1414 may be a bottom layer of cathode active material and the second layer may be a top layer of cathode active material.

Manufacturing method 600 may be performed using a dual-slot configuration, as described above, to simultaneously extrude the bottom and top cathode active material layers, or a multi-slot configuration with three or more dispensing orifices used to simultaneously extrude a cathode with three or more active material layers. In some embodiments, manufacturing system 1400 may include a tri-slot configuration, such that a first active material layer, a second active material layer, and a third active material layer may all be extruded simultaneously. In some embodiments, manufacturing system 1400 may include a tri-slot configuration, such that an electrochemically inactive conductive carbon layer, a first active material layer, and a second active material layer may all be extruded simultaneously. In another embodiment, subsequent active material layers may be applied after a previous layer has first dried.

### H. Illustrative Combinations and Additional Examples

This section describes additional aspects and features of cathodes having tailored crystallinities, presented without limitation as a series of paragraphs, some or all of which may be alphanumerically designated for clarity and efficiency. Each of these paragraphs can be combined with one or more other paragraphs, and/or with disclosure from elsewhere in this application, including any attached Appendices, in any suitable manner. Some of the paragraphs below may expressly refer to and further limit other paragraphs, providing without limitation examples of some of the suitable combinations.

A0. A cathode for an electrochemical cell, the cathode comprising:

a current collector;

a first layer layered onto the current collector, the first layer comprising a first active material blend; and

a second layer layered onto the first layer, the second layer comprising a second active material blend;

wherein the first active material blend comprises polycrystalline active materials; and

wherein the second active material blend comprises at least 50% single-crystal active materials.

A1. The cathode of paragraph A0, wherein the polycrystalline active materials and the single-crystal active materials comprise lithiated transition metal oxide materials containing nickel.

A2. The cathode of paragraph A1, wherein the lithiated transition metal oxide materials comprise at least 60% nickel.

A3. The cathode of any one of paragraphs A0 through A2, wherein the first layer has a first thickness, wherein the second layer has a second thickness, and wherein a ratio between the first thickness and the second thickness is between 1:3 and 3:1.

A4. The cathode of paragraph A3, wherein the ratio between the first thickness and the second thickness is 1:1.

A5. The cathode of any one of paragraphs A0 through A4, wherein a thickness of the cathode is between 50 μm and 150 μm.

B0. A cathode for an electrochemical cell, the cathode comprising:

a current collector;

a first active material layer comprising a first active material blend;

a second active material layer layered onto the first layer, the second layer comprising a second active material blend; and

a non-electrochemically active carbon conductive layer disposed between the first layer and the current collector;

wherein the first active material blend comprises polycrystalline active materials; and

wherein the second active material blend comprises at least 50% single-crystal active materials.

B1. The cathode of paragraph B0, wherein the polycrystalline active materials and the single-crystal active materials comprise lithiated transition metal oxide materials containing nickel.

B2. The cathode of paragraph B1, wherein the lithiated transition metal oxide materials comprise at least 60% nickel.

B3. The cathode of any one of paragraphs B0 through B2, wherein the first active material layer has a first thickness, wherein the second active material layer has a second thickness, and wherein a ratio between the first thickness and the second thickness is between 1:3 and 3:1.

B4. The cathode of paragraph B3, wherein the ratio between the first thickness and the second thickness is 1:1.

B5. The cathode of any one of paragraphs B0 through B4, wherein a thickness of the cathode is between 50 μm and 150 μm.

B6. The cathode of any one of paragraphs B0 through B5, wherein a thickness of the non-electrochemically active carbon conductive layer is between 1 μm and 10 μm.

C0. A cathode for an electrochemical cell, the cathode comprising:

a current collector;

a first layer layered onto the current collector, the first layer comprising a first active material blend;

a second layer layered onto the first layer, the second layer comprising a second active material blend including porous carbon conductive particles configured to provide ion channels within the second layer;

wherein the first active material blend comprises polycrystalline active materials; and

wherein the second active material blend comprises at least 50% single-crystal active materials.

C1. The cathode of paragraph C0, wherein the polycrystalline active materials and the single-crystal active materials comprise lithiated transition metal oxide materials containing nickel.

C2. The cathode of paragraph C1, wherein the lithiated transition metal oxide materials comprise at least 60% nickel.

C3. The cathode of any one of paragraphs C0 through C2, wherein the first layer has a first thickness, wherein the second layer has a second thickness, and wherein a ratio between the first thickness and the second thickness is between 1:3 and 3:1.

C4. The cathode of paragraph C3, wherein the ratio between the first thickness and the second thickness is 1:1.

C5. The cathode of any one of paragraphs C0 through C4, wherein a thickness of the cathode is between 50 μm and 150 μm.

C6. The cathode of any one of paragraphs C0 through C5, wherein the porous carbon conductive particles have a diameter between 1 μm and 50 μm.

D0. A method of manufacturing a cathode, the method comprising:

layering a first active material composite including a plurality of first active material particles onto a current collector, the first active material particles comprising polycrystalline active materials;

layering a second active material composite including a plurality of second active material particles onto the first active material composite, the second active material particles including at least 50% single-crystal active material particles.

D1. The method of paragraph D0, further comprising calendering the cathode.

D2. The method of paragraph D0 or D1, further comprising combining the cathode with an anode to construct an electrochemical cell.

D3. The method of paragraph D2, further comprising packaging the electrochemical cell (e.g., by inserting the cell into a pouch or canister).

D4. The method of any one of paragraphs D0 through D3, further comprising adding a liquid electrolyte to the cathode.

D5. The method of any one of paragraphs D0 through D4, further comprising layering a non-electrochemically active carbon conductive material between the current collector and the first active material composite.

D6. The method of any one of paragraphs D0 through D4, wherein the second active material composite includes porous carbon conductive particles configured to provide ion channels within the second active material composite.

E0. A cathode for an electrochemical cell, the cathode comprising:

a current collector;

a first layer disposed on the current collector, the first layer comprising a first active material blend; and

a second layer disposed on the first layer, the second layer comprising a second active material blend;

wherein the first active material blend consists essentially of polycrystalline active materials; and

wherein the second active material blend comprises at least 50% single-crystal active materials.

E1. The cathode of E0, wherein the polycrystalline active materials and the single-crystal active materials comprise lithiated transition metal oxide materials.

E2. The cathode of E1, wherein the lithiated transition metal oxide materials comprise at least 60% nickel.

E3. The cathode of any one of paragraphs E0 through E2, wherein the first layer has a first thickness, wherein the second layer has a second thickness, and wherein a ratio between the first thickness and the second thickness is from 1:3 to 3:1.

E4. The cathode of E3, wherein the ratio between the first thickness and the second thickness is 1:1.

E5. The cathode of any one of paragraphs E0 through E4, wherein a thickness of the cathode is 50 μm to 150 μm.

F0. A cathode for an electrochemical cell, the cathode comprising:

a current collector;

a non-electrochemically active carbon conductive layer disposed on the current collector;

a first layer disposed on the non-electrochemically active carbon conductive layer, the first layer comprising a first active material blend; and

a second layer disposed on the first layer, the second layer comprising a second active material blend;

wherein the first active material blend comprises polycrystalline active materials; and

wherein the second active material blend comprises at least 50% single-crystal active materials.

F1. The cathode of F0, wherein the polycrystalline active materials and the single-crystal active materials comprise lithiated transition metal oxide materials;

wherein the lithiated transition metal oxide materials comprise at least 60% nickel;

wherein a ratio of a first thickness of the first layer to a second thickness of the second layer is in a range from 1:3 to 3:1; and

wherein a thickness of the cathode is 50 μm to 150 μm.

F2. The cathode of F0 or F1, wherein the second layer comprises porous carbon conductive particles providing ion channels within the second layer.

G0. A method of manufacturing a cathode, the method comprising:

layering a first active material composite including a plurality of first active material particles onto a current collector, the first active material particles comprising polycrystalline active materials; and

layering a second active material composite including a plurality of second active material particles onto the first active material composite, the second active material particles including at least 50% single-crystal active material particles.

G1. The method of G0, further comprising calendering the cathode.

G2. The method of G0 or G1, further comprising combining the cathode with an anode to construct an electrochemical cell.

G3. The method of claim G2, further comprising packaging the electrochemical cell.

G4. The method of G3, further comprising adding a liquid electrolyte to the cathode.

G5. The method of any one of paragraphs G0 through G4, further comprising layering a non-electrochemically active carbon conductive material between the current collector and the first active material composite.

G6. The method of any one of paragraphs G0 through G5, wherein the second active material composite includes porous carbon conductive particles configured to provide ion channels within the second active material composite.

H0. A method of manufacturing a cathode, the method comprising:

coating a current collector with a non-electrochemically active carbon conductive layer;

layering a first active material composite including a plurality of first active material particles onto the non-electrochemically active carbon conductive layer, the first active material particles comprising polycrystalline active materials; and

layering a second active material composite including a plurality of second active material particles onto the first active material composite, the second active material particles including at least 50% single-crystal active material particles.

J0. A cathode for an electrochemical cell, the cathode comprising:

a current collector;

a first layer disposed on and directly contacting the current collector, the first layer comprising a first plurality of active material particles consisting essentially of polycrystalline active material particles; and

a second layer disposed on and directly contacting the first layer, the second layer comprising a second plurality of active material particles comprising at least 50% single-crystal active material particles by volume.

J1. The cathode of J0, wherein the polycrystalline active material particles and the single-crystal active material particles comprise lithiated transition metal oxides.

J2. The cathode of J1, wherein the polycrystalline active material particles and the single-crystal active material particles have a stoichiometric nickel percentage of at least 60%.

J3. The cathode of any one of paragraphs J0 through J2, wherein the first layer has a first thickness, wherein the second layer has a second thickness, and wherein a ratio between the first thickness and the second thickness is in a range from 1:3 to 3:1.

J4. The cathode of J3, wherein the ratio between the first thickness and the second thickness is 1:1.

J5. The cathode of any one of paragraphs J0 through J4, wherein a thickness of the cathode is 50 μm to 150 μm.

J6. The cathode of any one of paragraphs J0 through J5, wherein the first layer further comprises a first binder and the second layer further comprises a second binder.

K0. A cathode for an electrochemical cell, the cathode comprising:

a current collector;

an electrochemically inactive carbon conductive layer disposed on the current collector;

a first layer disposed on the electrochemically inactive carbon conductive layer, the first layer comprising a plurality of active material particles consisting essentially of polycrystalline active material particles; and

a second layer disposed on the first layer, the second layer comprising a second plurality of active material particles comprising at least 50% single-crystal active material particles by volume.

K1. The cathode of K0, wherein the second layer comprises porous carbon conductive particles configured to provide ion conduction channels within the second layer.

K2. The cathode of K0 or K1, wherein the polycrystalline active material particles and the single-crystal active material particles comprise lithiated transition metal oxides.

K3. The cathode of K2, wherein the polycrystalline active material particles and the single-crystal active material particles have a stoichiometric nickel percentage of at least 60%.

K4. The cathode of any one of paragraphs K0 through K3, wherein a ratio of a first thickness of the first layer to a second thickness of the second layer is in a range from 1:3 to 3:1

K5. The cathode of K4, wherein a thickness of the cathode is 50 μm to 150 μm.

L0. An electrochemical cell, the electrochemical cell comprising:

an anode; and

a cathode comprising:
a current collector;
a first layer disposed on and directly contacting the current collector, the first layer comprising a first plurality of active material particles consisting essentially of polycrystalline active material particles; and
a second layer disposed on and directly contacting the first layer, the second layer comprising a second plurality of active material particles comprising at least 50% single-crystal active material particles by volume

L1. The electrochemical cell of L0, wherein the polycrystalline active material particles and the single-crystal active material particles comprise lithiated transition metal oxides.

L2. The electrochemical cell of L1, wherein the polycrystalline active material particles and the single-crystal active material particles have a stoichiometric nickel percentage of at least 60%.

L3. The electrochemical cell of any one of paragraphs L0 through L2, wherein the first layer has a first thickness, wherein the second layer has a second thickness, and wherein a ratio between the first thickness and the second thickness is in a range from 1:3 to 3:1.

L4. The electrochemical cell of L3, wherein the ratio between the first thickness and the second thickness is 1:1.

L5. The electrochemical cell of any one of paragraphs L0 through L4, wherein a thickness of the cathode is 50 μm to 150 μm.

L6. The electrochemical cell of any one of paragraphs L0 through L5, further comprising a separator disposed between the anode and the cathode.

M0. A method of manufacturing a cathode, the method comprising: layering an electrochemically inactive carbon conductive material onto a current collector.

layering a first active material composite including a plurality of first active material particles onto the electrochemically inactive carbon conductive material, the first active material particles comprising polycrystalline active materials; and

layering a second active material composite including a plurality of second active material particles onto the first active material composite, the second active material particles including at least 50% single-crystal active material particles.

M1. The method of M0, further comprising calendering the cathode.

M2. The method of M1, wherein calendering the cathode causes a ratio between a first thickness of the first active material composite and a second thickness of the second active material composite to be in a range from 1:3 to 3:1.

M3. The method of M1, wherein calendering the cathode causes a thickness of the cathode to be from 50 μm to 150 μm.

M4. The method of any one of paragraphs M0 through M3, wherein the second active material composite includes porous carbon conductive particles configured to provide ion conduction channels within the second active material composite.

M5. The method of any one of paragraphs M0 through M4, wherein the polycrystalline active materials and the single-crystal active materials comprise lithiated transition metal oxides.

M6. The method of M5, wherein the polycrystalline active materials and the single-crystal active materials have a stoichiometric nickel percentage of at least 60%.

### Advantages, Features, and Benefits

The different embodiments and examples of the cathodes having tailored crystallinities described herein provide several advantages over known fast-charging electrochemical cells and cathodes. For example, illustrative embodiments and examples described herein reduce impedance-increasing side reactions within cathodes, resulting in cells with lower impedance.

Additionally, and among other benefits, illustrative embodiments and examples described herein reduce cell impedance while avoiding an increase in cost caused by including only single-crystal active material particles.

Additionally, and among other benefits, illustrative embodiments and examples described herein reduce heating upon high-current delithiation.

No known system or device can perform these functions. However, not all embodiments and examples described herein provide the same advantages or the same degree of advantage.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A cathode for an electrochemical cell, the cathode comprising:
a current collector; and
an active material composite electrically coupled to the current collector, the active material composite comprising:
a first layer comprising a first plurality of active material particles comprising polycrystalline active material particles; and
a second layer disposed on and directly contacting a top surface of the first layer, the second layer comprising a second plurality of active material particles comprising at least 50% single-crystal active material particles by volume.

2. The cathode of claim 1, wherein the polycrystalline active material particles and the single-crystal active material particles comprise lithiated transition metal oxides.

3. The cathode of claim 2, wherein the polycrystalline active material particles and the single-crystal active material particles have a stoichiometric nickel percentage of at least 60%.

4. The cathode of claim 1, wherein the first layer has a first thickness, wherein the second layer has a second thickness, and wherein a ratio between the first thickness and the second thickness is in a range from 1:3 to 3:1.

5. The cathode of claim 4, wherein the ratio between the first thickness and the second thickness is 1:1.

6. The cathode of claim 1, wherein the first plurality of active material particles consist essentially of polycrystalline active material particles.

7. The cathode of claim 1, wherein the first layer further comprises a first binder and the second layer further comprises a second binder.

8. The cathode of claim 1, further comprising:
an electrochemically inactive carbon conductive layer disposed on a bottom surface of the first layer.

9. The cathode of claim 8, wherein the second layer comprises porous carbon conductive particles providing ion conduction channels within the second layer.

10. The cathode of claim 8, wherein the polycrystalline active material particles and the single-crystal active material particles comprise lithiated transition metal oxides.

11. The cathode of claim 10, wherein the polycrystalline active material particles and the single-crystal active material particles have a stoichiometric nickel percentage of at least 60%.

12. The cathode of claim 8, wherein a ratio of a first thickness of the first layer to a second thickness of the second layer is in a range from 1:3 to 3:1

13. The cathode of claim 12, wherein the first plurality of active material particles consist essentially of polycrystalline active material particles.

14. A method of manufacturing a cathode, the method comprising:
layering an electrochemically inactive carbon conductive material onto a current collector.
layering a first active material composite including a plurality of first active material particles onto the electrochemically inactive carbon conductive material, the first active material particles comprising polycrystalline active materials; and
layering a second active material composite including a plurality of second active material particles onto the first active material composite, the second active material particles including at least 50% single-crystal active material particles.

15. The method of claim 14, further comprising calendering the cathode.

16. The method of claim 15, wherein calendering the cathode causes a ratio between a first thickness of the first active material composite and a second thickness of the second active material composite to be in a range from 1:3 to 3:1.

17. The method of claim 15, wherein calendering the cathode causes a thickness of the cathode to be from 50 μm to 150 μm.

18. The method of claim 14, wherein the second active material composite includes porous carbon conductive particles configured to provide ion conduction channels within the second active material composite.

19. The method of claim 14, wherein the polycrystalline active materials and the single-crystal active materials comprise lithiated transition metal oxides.

20. The method of claim 19, wherein the polycrystalline active materials and the single-crystal active materials have a stoichiometric nickel percentage of at least 60%.
